(19) United States
(12) Patent Application Publication
(10) Pub. No.: US 2015/0352889 A1
(43) Pub. Date: Dec. 10, 2015

(54) Magnetic Paper Holder with a Fastening Pin Member

(71) Applicant: Christian Oziel Quinones, Westminster, CO (US)

(72) Inventor: Christian Oziel Quinones, Westminster, CO (US)

(21) Appl. No.: 14/298,927

(22) Filed: Jun. 8, 2014

(51) Int. Cl. B42F 1/00; F16M 13/02; F16B 1/00

(52) U.S. Cl. CPC B42F 1/00; F16B 1/00; F16M 13/02; F16B 2001/0035

(57) ABSTRACT

A magnetic paper holder with a fastening pin member (10) for use on fabric-paneled cubicle walls is disclosed that holds paper effectively against creasing and provides a method by which the paper can be clamped at any location within its perimeter. The magnetic paper holder (10) is comprised of a first body (20) and a second body (30) containing a first magnet (26) and a second magnet (34), respectively, and a fastening pin member (24) for attaching the magnetic paper holder (10) to fabric-paneled cubicle walls. It is through the attractive force of the first magnet (26) and the second magnet (34) that allows the magnetic paper holder (10) to clamp single or multiple sheets of paper.

### BACKGROUND

### Prior Art

The following is a tabulation of some prior art that presently appears relevant:

U.S Patents

| Patent Number | Kind Code | Issue Date | Patentee |
|---|---|---|---|
| 7,891,616 | B2 | 2011 Feb. 22 | Pinchuk et al. |
| 6,923,411 | B2 | 2005 Aug. 2 | Chen et al. |
| D477364 | S | 2003 Jul. 15 | Tsai |
| 6,325,345 | B1 | 2001 Dec. 4 | Carpenter |
| 5,269,485 | | 1993 Dec. 14 | Dwinell et al. |

U.S Patent Application Publications

| Publication Number | Kind Code | Publication Date | Applicant |
|---|---|---|---|
| 2011/0314643 | A1 | 2011 Dec. 29 | Huang |

It is common to use fabric-paneled cubicle walls for attaching sheets of paper containing work-related or personal content. To hold these sheets of paper, conventional devices such as thumb tacks, push pins and clips are typically employed in many modern offices.

Although thumb tacks and push pins are easy to use and inexpensive to manufacture, they must penetrate through the paper in order to work effectively. This results in a permanent pierced hole through the paper which can be undesirable. Additionally, the simple design of these devices presents the disadvantage of a weak attachment that is subject to mounting instability.

Another conventional device that has been designed to hold paper on cubicle walls is the spring loaded clip which uses a pin arrangement for mounting on the cubicle wall. This design presents the disadvantage of leaving unsightly wrinkles or creases on the paper in the area being clamped by the clip. Additionally, this design restricts where the paper can be clamped within its perimeter, limiting how the paper can be oriented on the cubicle. Furthermore, operating a spring loaded clip can be a strenuous task for those with physical and developmental limitations.

Yet another example of a device designed to hold paper on cubicle walls is the adhesive fastening device found in U.S. Pat. No. 5,269,485 (1993) to Dwinell et al. A disadvantage of this design is that it allows no more than one sheet of paper to be affixed, and depends on adhesives which can be inherently weak if not permanent.

Several types of paper holding devices for fabric-paneled cubicle walls have been proposed—for example, U.S. patent D477,364 S (2003) to Tsai, U.S. patent D439,145 S (2001) to Carpenter and the aforementioned U.S. Pat. No. 5,269,485 (1993) to Dwinell et al. Although capable of holding paper, these devices present some disadvantages such as limiting where the sheets can be clamped from, leaving unsightly wrinkles or creases on the paper due to the grip patterns of the clamping jaws, and limiting the paper capacity.

There is a need for a paper holding device that can be mounted on fabric-paneled cubicle walls and mitigate the aforementioned problems. This device should be inexpensive to manufacture and relatively easy to use.

### SUMMARY

In accordance with one embodiment, a magnetically coupled paper holder for fabric-paneled cubicle walls is provided. The paper holder comprises a first body having a first base, a first magnet and a double-pronged fastening pin member; and a second body having a second base and a second magnet. There is an attractive force between the first magnet and the second magnet, thereby clamping the paper and providing an inherently strong paper holder.

### ADVANTAGES

Accordingly, several advantages of one or more aspects are as follows: to provide a magnetic paper holder that can be mounted on fabric-paneled cubicle walls; that will hold paper effectively against creasing; that can hold more than one sheet of paper; that is easy to operate; and that can provide a method by which the paper can be clamped at any location within its perimeter, not limited to being clamped by its edges.

### DRAWINGS

### Figures

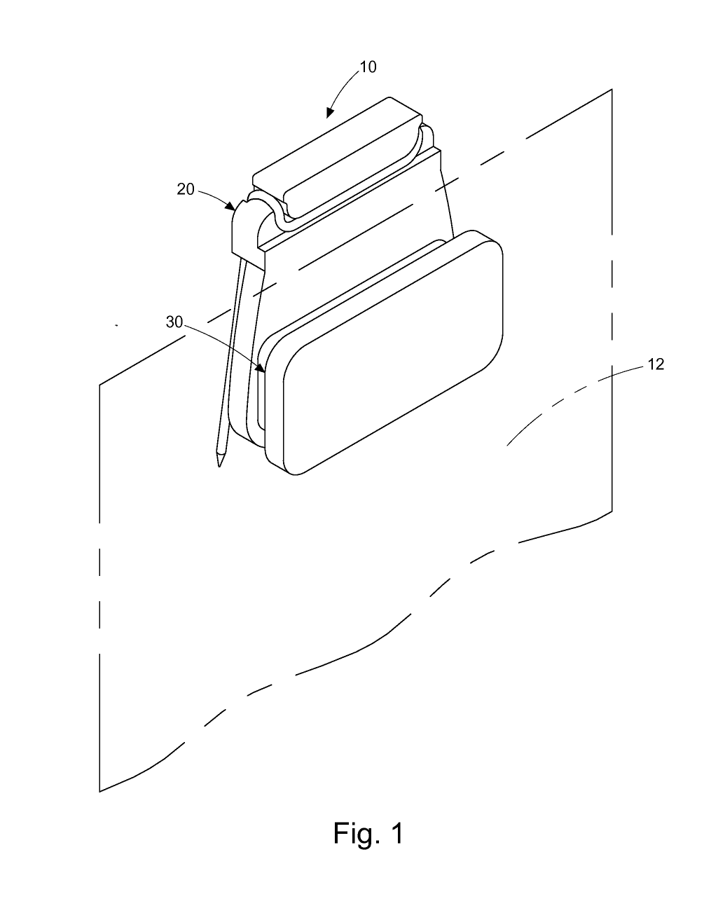

FIG. 1 is a perspective view of the magnetic paper holder in use holding a sheet of paper.

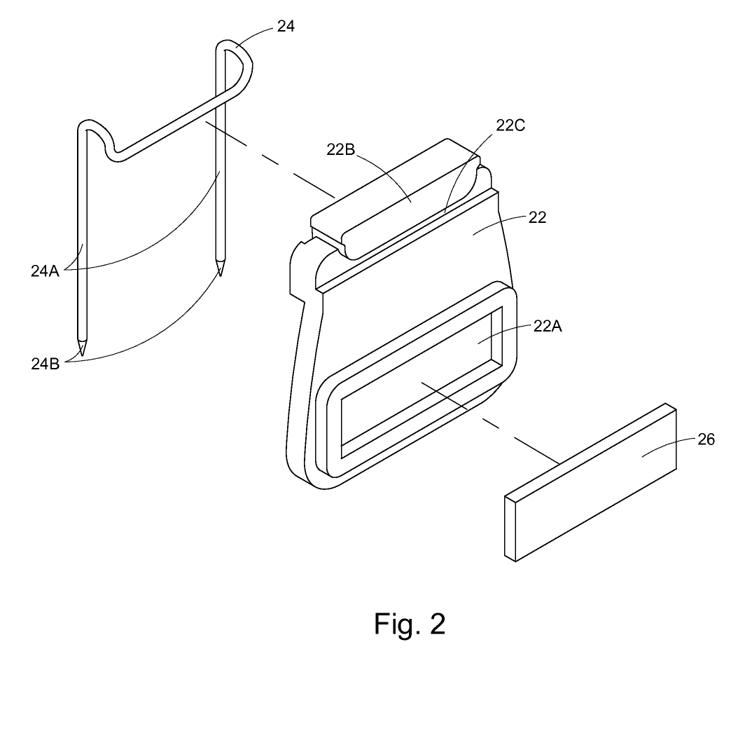

FIG. 2 is an exploded perspective view of the first body.

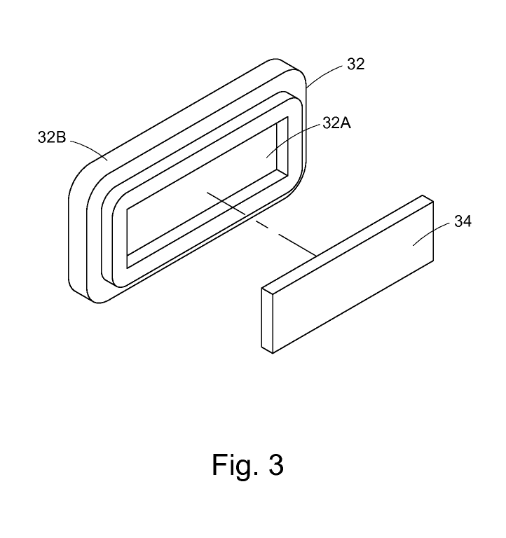

FIG. 3 is an exploded perspective view of the second body.

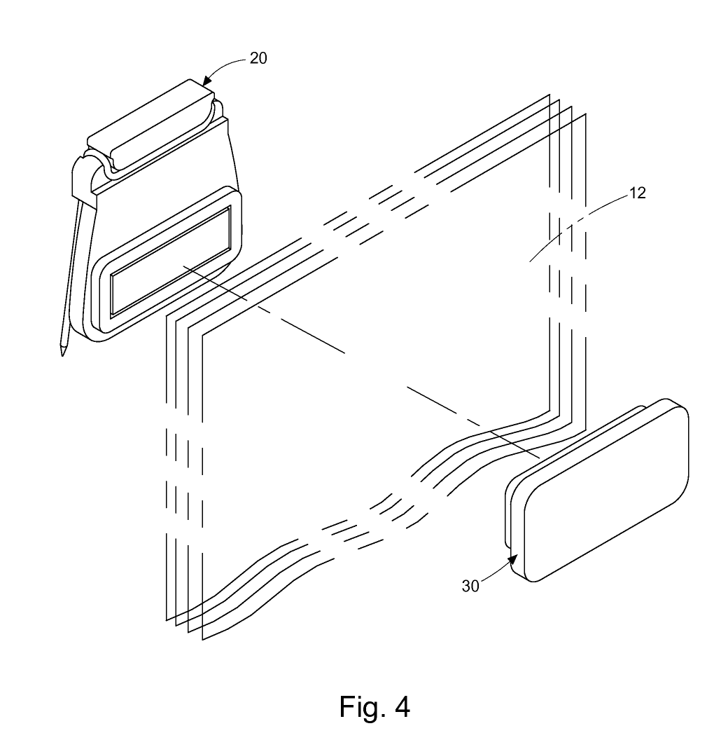

FIG. 4 is perspective view of the magnetic paper holder prior to engagement with multiple sheets of paper shown.

Drawings - Reference Numerals

| | |
|---|---|
| 10 | magnetic paper holder |
| 12 | sheet of paper |
| 20 | first body |
| 22 | first base |
| 22A | first magnet slot |
| 22B | pin attachment flange |
| 22C | pin attachment groove |
| 24 | double-pronged fastening pin member |
| 24A | parallel prongs |
| 24B | prong ends points |
| 26 | first magnet |
| 30 | second body |
| 32 | second base |
| 32A | second magnet slot |
| 32B | base flange |
| 34 | second magnet |

### DETAILED DESCRIPTION

Referring now to the figures, FIG. 1 is a perspective view of the magnetic paper holder 10 in use holding a sheet of paper 12 shown in phantom lines. The magnetic paper holder 10 comprises a first body 20 and a second body 30.

As can be seen in FIG. 2, the first body 20 comprises a first base 22, a double-pronged fastening pin member 24 and a first magnet 26. The first base 22 contains a first magnet slot 22A in which the first magnet 26 is mounted in place using adhesives, mechanical attachment techniques or a combination thereof. Mechanical attachment techniques include, but are not limited to, gland sliding parts, snap fit, press fit or the like. The first magnet 26 may also be fully or partially incased within the first base 22. The double-pronged fastening pin member 24 is constructed from spring wire, which is bent in such a manner that it can snap in place over the pin attachment flange 22B and can be restrained in place with its horizontal extension rested in the pin attachment groove 22C. As can be seen in FIG. 2, the double-pronged fastening pin member 24 contains two parallel prongs 24A with sharpened prong ends points 24B for penetrating the fabric-paneled cubicle wall.

Referring to FIG. 3, the second body 30 comprises a second base 32 and a second magnet 34. Similarly to the first base 22 shown in FIG. 2, the second base 32 contains a second magnet slot 32A in which the second magnet 34 is mounted in place using adhesives, mechanical attachment techniques or a combination thereof. Mechanical attachment techniques include, but are not limited to, gland sliding parts, snap fit, press fit or the like. The second magnet 34 may also be fully or partially incased within the second base 32. As shown in FIG. 3, the second base 32 contains a base flange feature 32B which extends outwardly so that the user can grip and easily engage and disengage the magnetic paper holder 10.

The first base 22 and the second base 32 shown in FIG. 2 and FIG. 3, respectively, may be made from a metal such as aluminum or may be made from a plastic such as Acrylonitrile-Butadiene-Styrene Copolymer (ABS). Conventional manufacturing methods such as injection molding or 3-D printing methods can be used. The first magnet 26 and the second magnet 34 may be ceramic magnets, rare earth magnets such as Neodymium or Samarium Cobalt, or the like. Stronger magnets may be used to increase the paper capacity. The magnets and the related slots may be generally rectangular, or in some embodiments may be circular, triangular or of another shape.

### Operation

The manner of installing and using the magnetic paper holder 10 to hold single or multiple sheets of paper on fabric-paneled cubicle walls is described in this section. A second perspective view of the magnetic paper holder is shown in FIG. 4, where the first body 20 and the second body 30 are shown to be uncoupled with multiple sheets of paper 12 held therebetween. With the first body 20 attached and fixed to the cubicle wall by the double-pronged fastening pin member 24, an attractive force of magnets of opposite polarity engages as one positions the second body 30 closer to the first body 20 with paper held therebetween. It is through the attractive force of the magnets that allows the paper to be clamped and held firmly.

To remove the paper, one decouples the magnetic paper holder by lifting the second body 30 outwardly and away from the first body 20, effectively weakening the attractive force of the magnets and thus allowing the paper to be removed. When the magnetic paper holder is not in use, the first body 20 and the second body 30 can be left engaged so that they do not become separated.

I claim:

1. A holding apparatus for attaching paper to a cubicle wall, the holding apparatus comprising:
a first body comprising a first magnet, a first magnet slot and a fastening pin member;
a second body comprising a second magnet and a second magnet slot:
whereby paper is clamped between the first body and second body through the attractive force of the first magnet and the second magnet.

2. The holding apparatus of claim 1, wherein the said first or second magnet comprises at least partly of a ferromagnetic material.
